(19) United States
(12) Patent Application Publication
(10) Pub. No.: US 2005/0008303 A1
(43) Pub. Date: Jan. 13, 2005

(54) Optical module, an optical communication apparatus and a optical transceiver module

(76) Inventors: Mitsuaki Nishie, Yokohama-shi (JP); Yoshiki Kuhara, Osaka (JP)

Correspondence Address: MCDERMOTT WILL & EMERY LLP, 600 13TH STREET, N.W., WASHINGTON, DC, 20005-3096, US

(21) Appl. No.: 10/823,790

(22) Filed: Apr. 14, 2004

(30) Foreign Application Priority Data
Apr. 14, 2003 (JP) 2003-109176

(51) Int. Cl. G02B 6/36

(52) U.S. Cl. 385/92

(57) ABSTRACT

The present invention provides an optical module capable of simplifying the assembly thereof. The optical module has a first substrate, an electronic device mounted on the first substrate, an optical device electrically connected to the electronic device, a fiber assembly coupled to the optical device and a housing. The housing has a base and a cover. The base has an opening, into which the first substrate is inserted, and a mounting region where the optical device is mounted thereon. The base and the cover sandwiches and secures the fiber assembly therebetween. The first substrate may be connected to a second substrate provided outside of the optical module with a flexible or a resilient connecting member.

### BACKGROUND OF THE INVENTION

### Field of the Invention

The present invention relates to an optical module, an optical communication apparatus using the optical module, and an optical transceiver module.

A configuration of an optical transceiver have been well known that an optical sub-assembly installing an optical device is electrically connected to a circuit board, on which electronic devices such as a driver circuit and/or a processing circuit, with a flexible printed circuit. For example, Japanese patent published as H11-196055 and United States patent issued by U.S. Pat. No. 5,802,711 have disclosed such configuration.

Another configuration for the optical transceiver, that the housing thereof is divided into two parts, an upper and a lower housings, is known. One of parts installs a circuit board for the optical transmitting function while the other of parts installs a circuit board for the optical receiving function. Japanese patent published as H08-037500 has disclosed such configuration.

Still another configuration is known that the housing of the optical transceiver is divided into two portions, a front portion and rear portion. The front portion, called as a receptacle housing, includes an optical module and a mechanism to position the optical module toward the front side and directions perpendicular to the optical axis. The rear portion provides another mechanism to position the optical module toward the rear side. Japanese patent published as 2002-082261 and United States patent U.S. Pat. No. 5,663,526 have disclosed such configuration.

The optical transceivers mentioned above use optical sub-assemblies therein and the optical sub-assembly has a co-axial shape. However, such optical transceiver having co-axial optical sub-assembly has, in the other side, a subject to increase the assembling cost.

### SUMMARY OF THE INVENTION

Therefore, one object of the present invention is to provide an optical module, an optical communication apparatus using the optical module, and an optical transceiver module having a configuration capable of simplifying the assembly thereof.

According to one aspect of the present invention, an optical module comprises a first substrate, an electronic device provided on the first substrate, an optical device electrically connected to the electronic device, a fiber assembly optically coupled to the optical device and a housing for securing the fiber assembly. The housing includes a cavity for enclosing the electronic device and the optical device, and an opening leading to the cavity. The first substrate is provided in the opening.

The housing may includes a base and a cover. The base has a mounting region, the optical device is mounted thereon. The cover has the cavity. The cover and the base secure the fiber assembly therebetween. The cover may include a groove for securing the fiber assembly therein. The base may also include a groove for securing the fiber assembly therein. The grooves provided in the base or the cover may include a first groove and a second groove extending from the first groove. The fiber assembly includes an optical fiber and a ferrule covering the optical fiber, and the first groove may secure the optical fiber while the second groove may secure the ferrule.

The optical module may further includes a bench for mounting the optical device and for securing the fiber assembly between the cover. The bench is mounted on a receiving portion of the base.

According to another aspect of the present invention, an optical communication apparatus is provided. The optical communication apparatus includes an optical module thus described, a second substrate and a wiring member that is resilient. The second substrate installs other electronic devices.

The wiring member may be a printed circuit board. The optical device and the electronic device both provided in the optical module may be a light-emitting device and a driver for driving the light-emitting device, respectively. The other electronic devices may constitute a signal processing circuit for generating a signal provided to the driver in the optical module. The optical device and the electronic device may be a light-receiving device and a pre-amplifier, respectively. The other electronic devices installed on the second substrate may constitute a signal processing circuit for processing a signal output from the pre-amplifier.

### BRIEF DESCRIPTION OF DRAWINGS

FIG. 1 is an exploded view showing an optical module according to the first embodiment of the present invention;

FIG. 2 is a cutaway perspective view of the first optical module;

FIG. 3A is a cross sectional view taken along the line I-I in FIG. 2, FIG. 3B is a cross sectional view taken along the line II-II in FIG. 2 and FIG. 3C is a cross sectional view taken along the ling III-III in FIG. 2;

FIG. 4 shows am optical module modified from the first embodiment;

FIG. 5 is an exploded view showing another optical module;

FIG. 6 is a cutaway perspective view of the another optical module;

FIG. 7 is a cross sectional view showing a configuration of light-reflecting surface of the groove;

FIG. 8 is an exploded view showing an optical module according to the second embodiment of the present invention;

FIG. 9A shows a substrate member prepared for an optical communication apparatus, FIG. 9B shows a substrate unit constituting the substrate member, and

FIG. 9C shows a step for installing the optical device and the electronic devices on respective substrates;

FIG. 10A shows a step of assembling the optical module with the first substrate, and FIG. 10B shows a step of wire-bonding for respective devices;

FIG. 11A shows the substrate member after the first substrate and the base have been mated with, FIG. 11B shows the optical communication apparatus after the cover is assembled with the base, and FIG. 11C shows the optical communication apparatus after the resin body have been molded;

FIG. 12A shows a substrate unit for the optical communication apparatus of the fourth embodiment of the present invention, FIG. 12B is a plan view of the optical communication apparatus using the substrate unit of FIG. 12A; and

FIG. 13A shows another substrate unit for the modified optical communication apparatus, FIG. 13B shows the optical communication apparatus using the substrate unit shown in FIG. 13A.

### DETAILED DESCRIPTION OF PREFERRED EMBODIMENTS

The spirit of the present invention will be understood as referring to drawings and explanation disclosed herein. Next, preferred embodiments of the present invention will be described as referring to accompanying drawings for an optical module, an optical communication apparatus, an optical transceiver and a method for manufacturing an optical communication apparatus. In the specifications and drawings, same elements will be referred as the same symbol or numeral without overlapping explanations.

(First Embodiment)

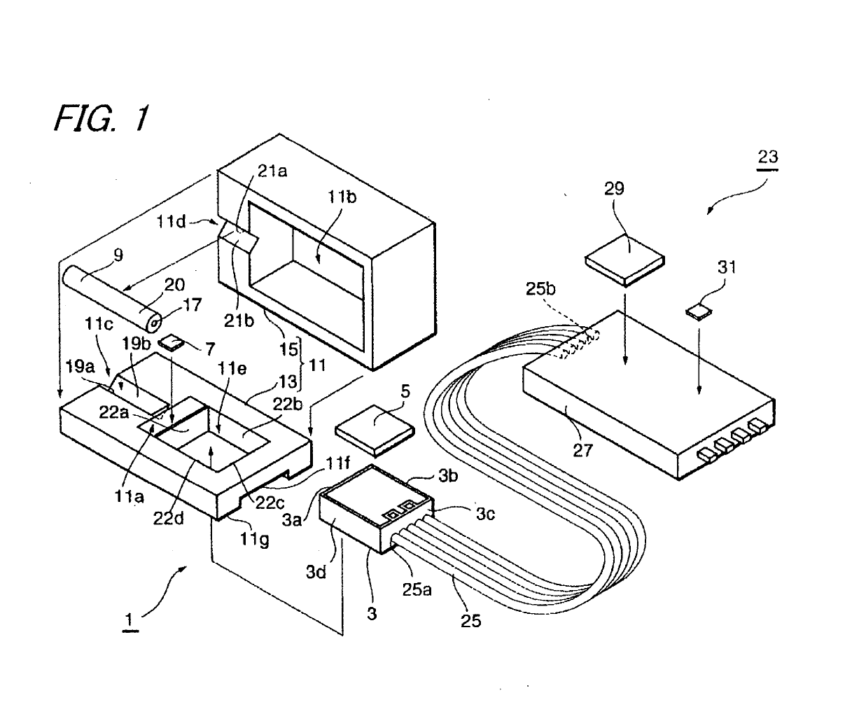

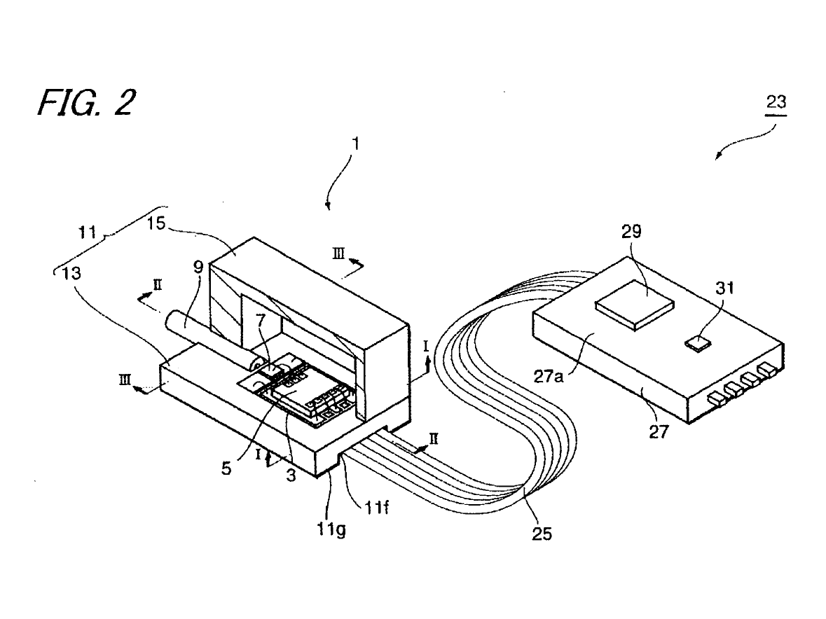

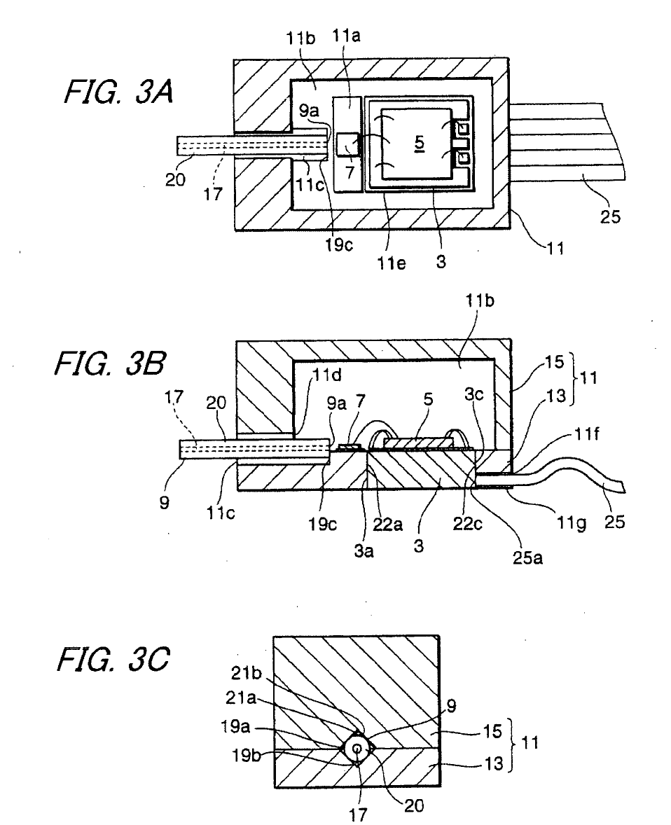

FIG. 1 is an exploded view showing a first embodiment of the present invention, and FIG. 2 is a perspective view of the optical module. FIG. 3A is a cross sectional view taken along the line I-I, FIG. 3B is a cross section view along the line II-II, and FIG. 3C is a cross sectional view taken along the line III-III in FIG. 2, respectively.

Referring to FIG. 1 and FIG. 2, the optical module 1 includes a first substrate 3, an electronic device 5 mounted on the first substrate 3, a optical device 7 electrically connected to the electronic device 5, a fiber assembly 9 optically coupled to the optical device 5, and a housing 11. The housing comprises a base 13 and a cover, on the base 13 is provided a mounting region 11a, a groove 11c and an opening 11e, while in the cover 15 is provided a cavity 11b and a groove 11. The mounting region mounts the optical device thereon. The cavity 11b receives the electronic device 5 and the optical device 7. Two grooves 11c and 11d are continued to the cavity 11b, and secure the fiber assembly, The first substrate 3 is disposed in the opening 11e. The base 13 and the cover may be made of resin.

The optical device 7 is wire-bonded to the electronic device 5 with a bonding-wire, and the electronic device 5 is also wire-bonded to the wiring pattern formed on the first substrate 3.

The fiber assembly 9 includes an optical fiber 17 and a ferrule 20 that secures and protects the optical fiber 17. The base 13 and the cover 15 co-operatively secure the fiber assembly therebetwee. The groove 11c on the base 13 has two surfaces 19a and 19b, while the groove 11d on the cover 15 also has two surfaces 21a and 21b. The fiber assembly 9 is secured by these two surfaces 19a and 19b in the groove 11c of the base 13 and other two surfaces 21a and 21b in the groove 11d of the cover 15. Accordingly, the optical device 7 on the base 13 can be optically coupled with the optical fiber 17 of the fiber assembly 9.

The opening 11e in the base 15 may include guide faces 22a to 22d to receive the first substrate 3 therein. On the other hand, the first substrate 3 has sides 3a to 3d. When the first substrate 3 is put in the opening, the sides 3a to 3d of the first substrate 3 slide on the respective guide faces 22a to 22d of the base 15.

Referring to FIG. 3A and FIG. 3B, the electronic device 5, the optical device 7, the optical fiber assembly 9, the groove 11c, the mounting region 11a, and the opening are arranged along an axis. Further, the groove 11c has an abutting surface 19c adding to the faces 19a and 19b, to which the tip 9a of the optical fiber is abutted, accordingly the optical device and the optical fiber may be coupled in a effective position with each other. This configuration of the optical module, especially in the base thereof, realizes a passive alignment between the optical fiber and the optical device.

Referring to FIG. 1 and FIG. 2 again, the optical communication apparatus 23 includes the optical module 1, a second substrate, a wiring member 25 for connecting the optical module 1 to the second substrate 27, and further electronic device 29 mounted on the second substrate 27. The wiring member 25 has an end 25a connected to the first substrate 3 of the optical module 1 and the other end 25b connected to the second substrate 27. Thus, the other electronic device 29 is connected to the electronic device 25 on the first substrate 3 via the wiring member 25.

The wiring member 25 includes one or more conductive wire, and an insulating and resilient sheath covering the conductive wire. In other form, the wiring member may be flexible printed circuit.

The optical device 7 may be a light-emitting device, and the electronic device 5 may be a driver for driving the light-emitting device 7. The other electronic device 27 may be a signal-processor for providing the driving-signal to the driver 5. The light-emitting device 7 may be a semiconductor laser diode, for instance a Fabry-Perot type laser diode or a distributed feedback (DFB) laser diode, a semiconductor optical amplifier, a semiconductor modulator, and a semiconductor optical integrated device. The semiconductor optical integrated device includes a light-emitting device and a light-modulating device, they are formed integrally in a unity body. The signal-processing device may include a de-multiplexer.

The additional substrate 27 of the present optical communication apparatus 23 enables to install more electronic devices compared to the conventional apparatus. Moreover, the configuration of the optical module 1 can be maintained in a simplified form because the additional substrate 27 is disposed outside of the optical module 1 and electrically connected via the wiring member 25.

The ferrule 20 may be made of ceramic or plastic, and the optical fiber 17 may be a single mode fiber or a multi-mode fiber. The multi-mode fiber may increase tolerance of the optical coupling efficiency between the optical fiber and the optical device, and also that between the external fiber and the internal fiber of the optical module 1.

The housing 11 provides a hollow 11f in the outer surface thereof, namely the bottom surface thereof opposite to the primary surface where the optical device is mounted thereon, to receive the wiring member 25. The hollow 11f, the shape of which is a groove or a bore, prevents the wiring member 25 from extruding from the outer surface of the housing 11.

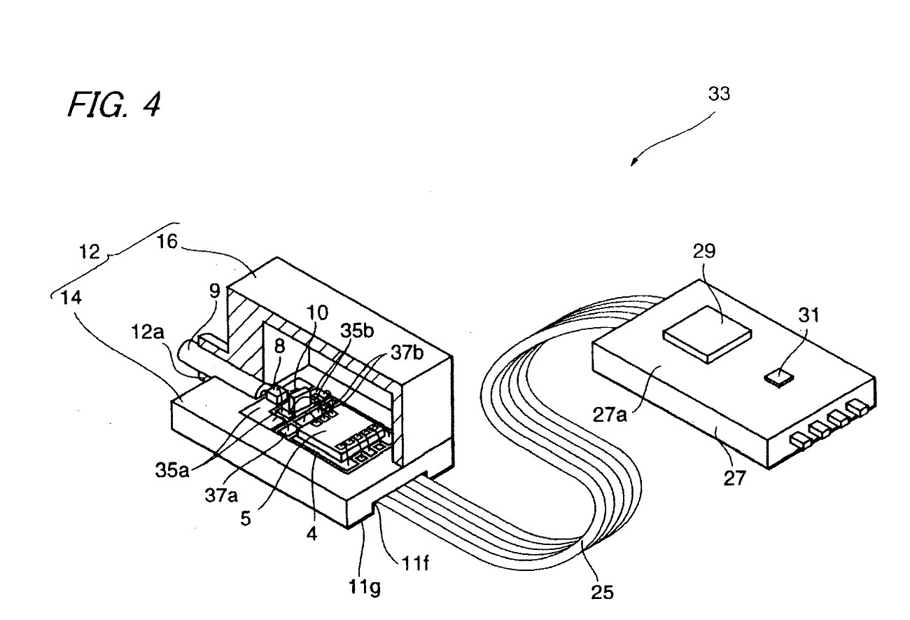

FIG. 4 shows a modified optical module 33, which further includes a light-receiving device 10 between the optical device 8 and the electronic device 5 for monitoring light emitted from the optical device 8. The light-receiving device 10 may be optically coupled with the optical device 8 via the base 14 where both devices 8 and 10 are mounted thereon. The optical device 8 us electrically connected to the wiring pattern 37a formed on the first substrate 4 and to the electronic device 5 via the wiring pattern 35a formed on the base 14. The electronic device 10 is electrically connected to the wiring pattern 37b formed on the first substrate 4 and to another wiring pattern 35b formed on the base 14.

In the present example shown in FIG. 4, the housing 12 may provide a projection 12a to guide and secure the fiber assembly 9. The projection 12a extends along the fiber assembly 9.

(Second Embodiment)

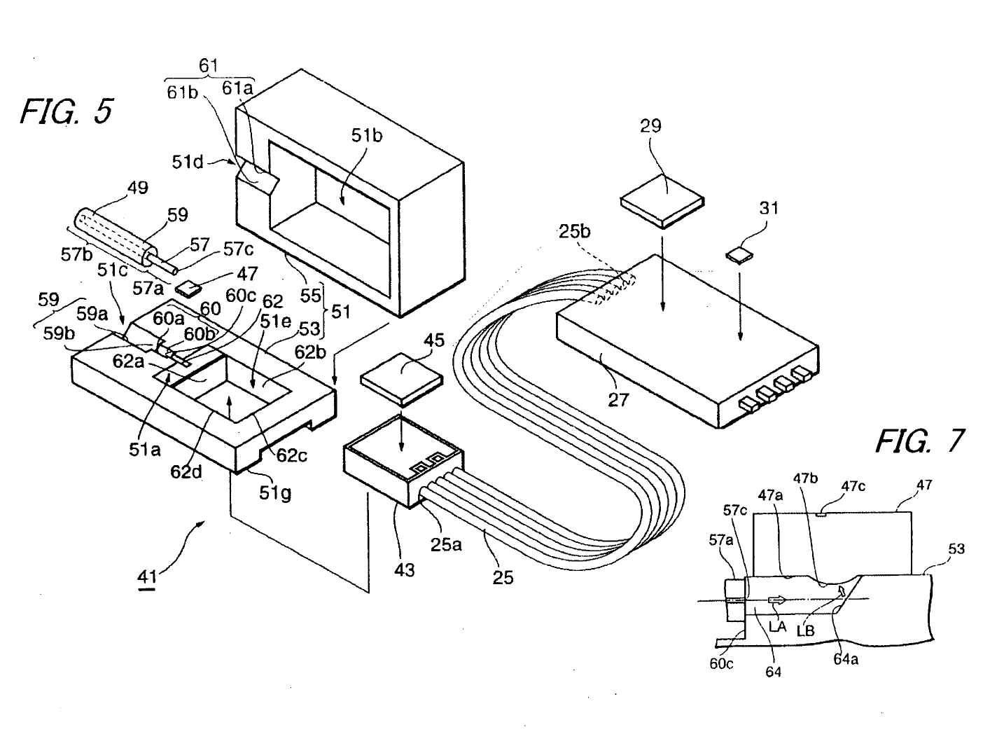

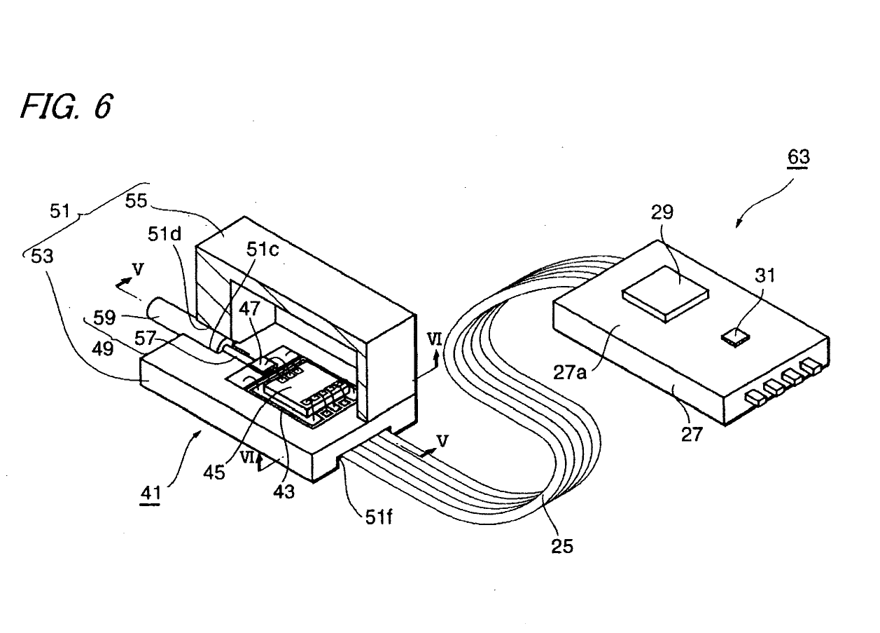

FIG. 5 is an exploded view and FIG. 6 is a perspective view showing the optical module 41 according to the second embodiment of the present invention.

In the optical module 41 according to the second embodiment, the optical fiber 57 includes a first portion 57a and a second portion 57b different to those shown in the first embodiment. The ferrule 59 secures and covers the second portion 57b of the optical fiber 57. The grooves 51c and 51d, each formed in the base 35 and the cover 55, respectively, include a pair of surfaces 59a and 59b, and/or another pair of surfaces 61a and 61b. These surfaces, 59a, 59b, 61a and 61b, secures the ferrule 59 of the fiber assembly 49, thereby optically coupling the optical fiber 57 with the semiconductor optical device 47.

The groove 51c further includes another groove 60 that also has a pair of surfaces 60a and 60b to secure the first portion 57a of the optical fiber 57, and the abutting surface 60c. The tip of the optical fiber 57c is abutted to the abutting surface 60c, thereby defining the position thereof along the optical axis.

FIG. 7 shows an arrangement in which the optical device 47, for example the light-receiving device, is coupled to the optical fiber 57. The base 53 includes a additional groove 64 thorough which the optical fiber 57 may be coupled with the optical device 47. The additional groove has a light-reflecting surface 64a in the end thereof. The light LA emitted from the tip of the optical fiber 57 is reflected at the light-reflecting surface 64a and converted to the light LB directed toward the optical device 47. The reflected light LB enters the incident surface 47a of the optical device 47 via the lens 47b monolithically formed on the incident surface 47b thereof, and finally reaches the active region 47c. The optical module 41 provides an configuration preferably fitting to the passive alignment.

The electronic device 5 in this embodiment may be a pre-amplifier for amplifying signal output from the optical device 47. The other electronic device 29 installed on the second substrate 27 may be a main amplifier for processing the signal output from the pre-amplifier 45. The light-receiving device 47 may be a pin photodiode or an avalanche photodiode.

(Third Embodiment)

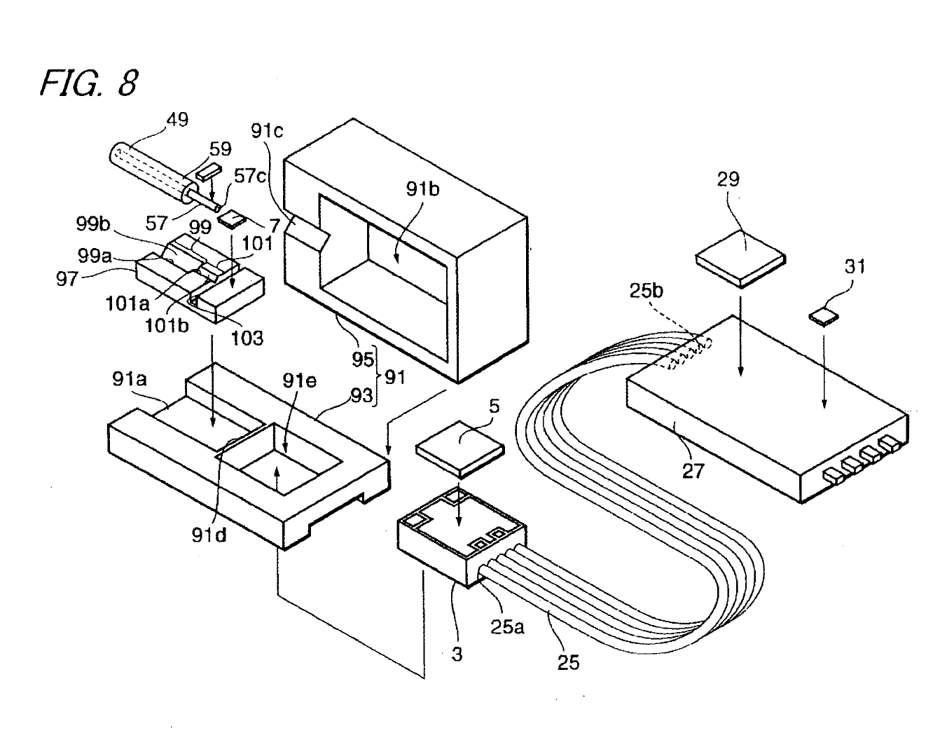

FIG. 8 is an exploded view showing an optical module 81 according to the third embodiment of the present invention.

The optical module 81 has a base 93 having a modified shape and a bench 97. The base 93 includes a hollow 91a for receiving the bench 97. The hollow 91a has the end face 91d, which intersects the optical axis, for defining the portion of the bench 97 in the hollow 91a. The bench 93 also has the opening 91e for receiving the first substrate 3. The first substrate 3 is inserted and fitted in the opening 91e of the base 93. Therefore, the bench 97 and the first substrate 3 is aligned with each other on the base 93. On the bench 97, the optical device 47 and the fiber assembly 57 are aligned with each other.

The bench 97 has a first grove 99 and a second grove 101 both arranged along the axis. The first grove 99 includes a pair of surfaces 99a and 99b for supporting the ferrule 59, while the second grove 101 includes a pair of surfaces 101a and 101b for supporting the optical fiber 57. The second grove 101 further has an end surface 103. The tip 57e of the optical fiber 57 is abutted to the end surface 103, thereby defining the position thereof on the bench 97 and optically aligning the optical fiber with the optical device 7.

Next, a method for manufacturing an optical communication apparatus according to the present invention will be described as referring to FIGS. from 9A to 11C.

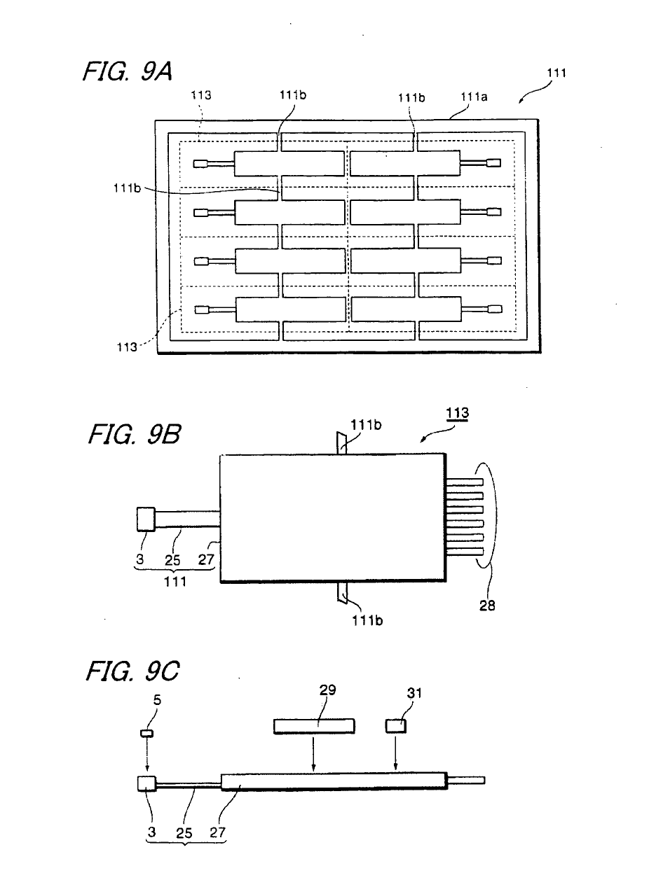

A substrate member 111 is prepared as shown in FIG. 9A. The substrate member 111 includes a frame 11a, a plurality of substrate units 113 each disposed in array form, and a plurality of supports 111b connecting each substrate units 113 to the frame 11a or connecting substrate units 113 to each other. The substrate unit 113 includes the first and the second substrates 3 and 27, respectively and the wiring member 25 connecting the first substrate 3 to the second substrate 27 as shown in FIG. 9B. The second substrate 27 provides a plurality of lead pins 28 in one edge thereof. In another configuration, the lead pins may be replaced to a card edge connector.

The electronic device 5 and the other electronic devices 29, 31 are mounted on the first 3 and the second 27 substrate, respectively, as shown in FIG. 9C. Subsequent to the mounting of the electronic devices, wiring patterns on the substrate 3 and 27 are connected to the electronic device 5 on the first substrate and to those 29 and 31 on the second substrate with bonding-wires. Next the cover 15 having the cavity 11b and the base 13 having the opening 11e are assembled with first substrate 3.

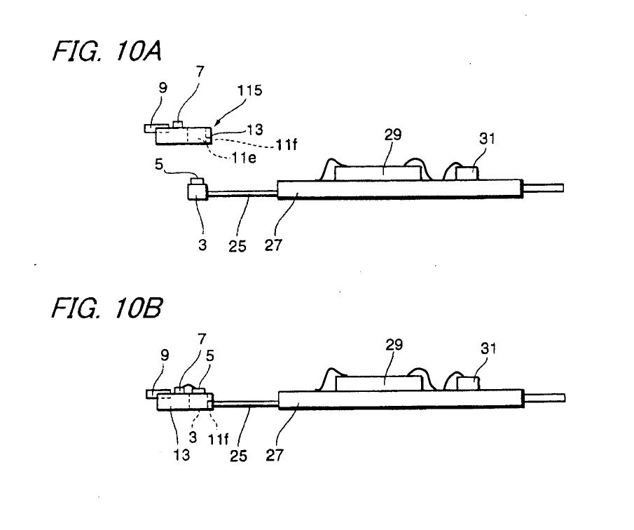

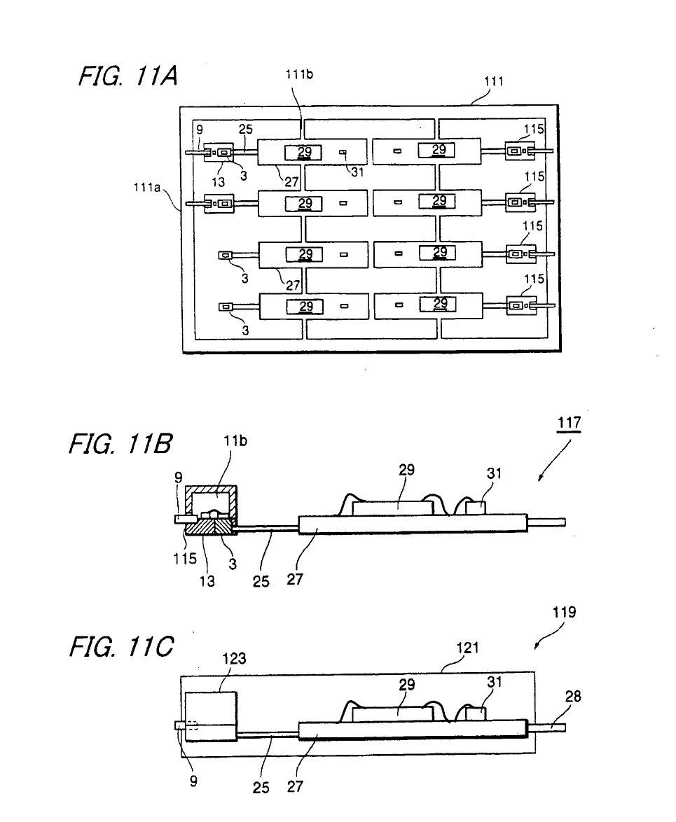

Next, the assembling of the housing 11 and the first substrate 3 will be described. As shown in FIG. 10A, the optical device 7 and the fiber assembly 9 is mounted on the base 13, both devices are optical aligned on the base 13. The first substrate 3 is inserted into the opening 11f of the base 13. FIG. 10B and FIG. 11A show the steps that the first substrate 3 is in the opening 11e and the one end of the fiber assembly 9 is positioned on and secured by the frame 111a. The wiring member 25 passes through the bottom of the base 13, namely, the bottom of the base 13 has a hollow through which the wiring member 25 passes, thereby flattening the bottom surface of the base 13. Subsequent to the assembling of the first substrate 3 into the opening 11e of the base 13, the optical device 7 on the base 13 is wire-bonded to the wiring pattern formed on the base 13 and to the electronic device 5 disposed on the first substrate 3.

After the cover 15 is provided on the base 13 and fixed thereto, the supports 111b are cut and the assemblies 117, which includes the first and the second substrates, the cover, and the base, are isolated to each other as shown in FIG. 11B. The assembly 117 thus manufactured is shown in, for example, FIG. 2. Finally, molding the assembly 117 with resin, the optical transmitting apparatus 119 can be obtained. The resin-molded body 121 of the optical transmitting apparatus 119 encloses the optical module 123, the wiring member 25, the second substrate 27, and the electronic devices 29 and 31 (FIG. 11C).

(Fourth embodiment)

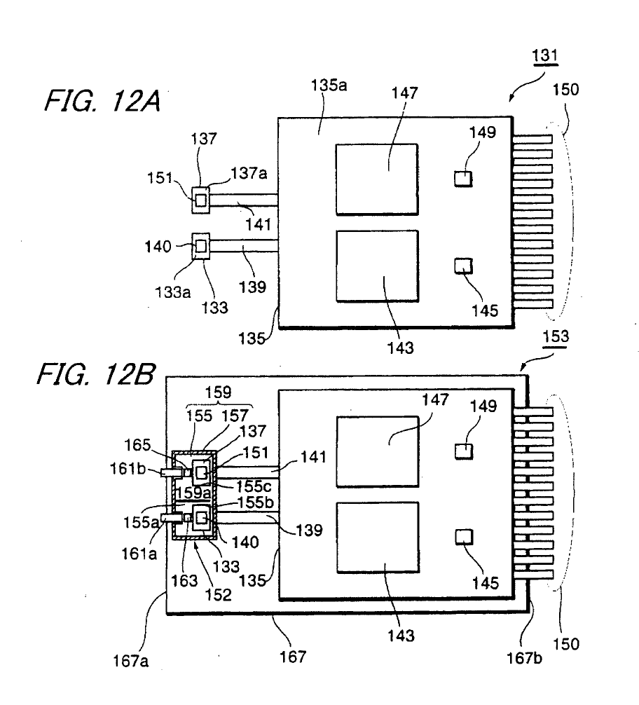

FIG. 12A is a plane view showing another substrate unit 131 of according to the present invention. The substrate unit 131 includes the first to the third substrates 133, 135 and 137, and the first and the second wiring member 139 and 141. The first wiring member 139, which is a flexible member, connects the first substrate 133 to the third substrate, while the second wiring member 141, which is also a flexible member, connects the second substrate to the third substrate. On the first substrate is mounted the electronic device 140, and on the second substrate 135 is mounted the other electronic device 143, 145, 147 and 149. On the third substrate 137 is mounted the electronic device 151. The electronic device 140 mounted on the first substrate is connected to the other electronic device 143 via the wiring member 138, and the electronic device 151 is connected to the other electronic device 147 via the wiring member 141. One edge of the second substrate 135 provides a plurality of lead pins 150 connected to the electronic devices 143 and 147. In this embodiment, the first and the second wiring member may be a flexible printed circuit.

FIG. 12B is a plan view of the optical module 152 and the optical transmitting apparatus 153 using the unit 131 of FIG. 12A. The optical module 152 has single base commonly provided to the optical transmitting portion and the optical receiving portion. On the base 155 is mounted the first and the second optical devices 163 and 165, and is formed two openings 155b ad 155c. In the opening 155b is positioned by the first substrate 133, while in the opening 155c is inserted by the third substrate 133. Further, two fiber assembly 161a and 161b are also mounted on the base 155, which are optically coupled with respective optical devices 161a and 161b via the base 155. The cover 157 is disposed so as to cover two optical devices 163 and 165, two electronic devices 140 and 151, and two fiber assemblies 161a and 16b.

The optical transmitting apparatus 153 may also include the body 167 made of mold resin and encapsulating the wiring member 139 and 141, and the second substrate 135. One side of the body 167a is protruded the tips of the fiber assembly 161a and 161b, while another side 167b of the body is disposed the plurality of lead pins.

The first optical device 163 may be a light-emitting device, while the second optical device 165 may be a light-receiving device. In another configuration, the first and the second optical devices 163 and 165 may be light-receiving devices, or still in another embodiment, the first and the second optical devices 163 and 165 may be light-transmitting devices.

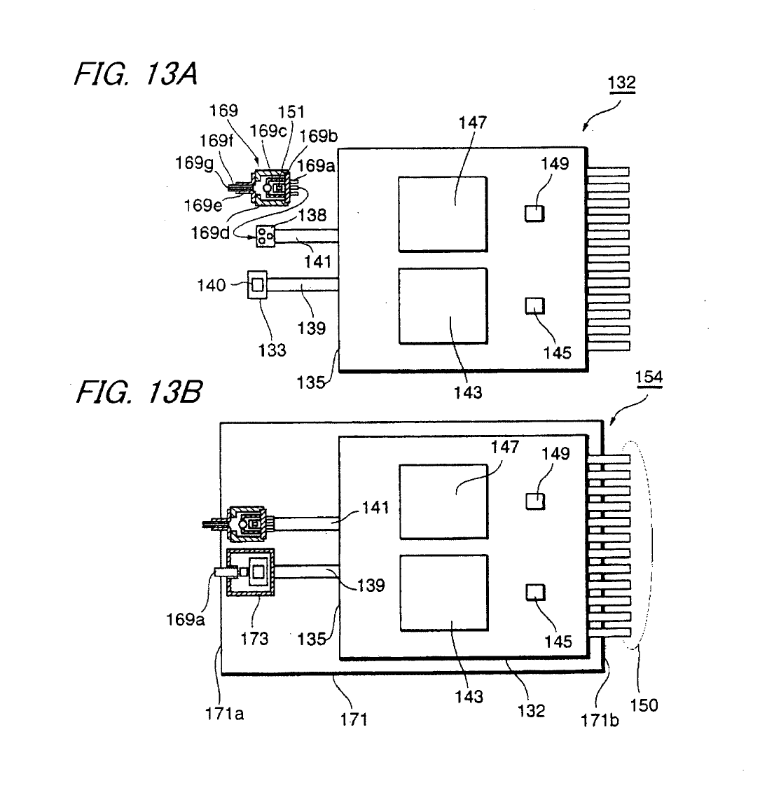

FIG. 13A is a plan view showing still another substrate unit 132, and FIG. 13B is a plan view showing the optical communication apparatus 154 using the substrate unit 132. The substrate unit 132 according to the present embodiment has a third substrate 138 adequate for the optical sub-assembly 169 having the co-axial shape. The optical sub-assembly 169 with the co-axial shape comprises a stem 169b, a lens cap 169c, a first sleeve 169d, and a second sleeve 169e. The second sleeve 169d receives and secures the ferrule 169f. A plurality of lead pins 169a is extended from the stem 169b, to which the third substrate is electrically connected. The optical device 151 is mounted on the stem 169b, thus coupled to the optical fiber 169g provided in the ferrule 169f.

The optical communication apparatus 154 also has a resin body 171 that molds the transmitting optical sub-assembly 169, the optical module 173, the wiring members 139 and 141, and the second substrate 135. The ferrule 169f of the transmitting optical sub-assembly 169 and the ferrule assembly 169a are protruded from an one side 171a of the resin body 171. Another side 171b thereof is disposed a plurality of lead pins.

From the invention thus described, the invention and its application may be varied in many ways. For example, the arrangement of the optical module and the optical communication apparatus is not restricted to those specified and shown in embodiments above described. Such variations are not to be regarded as a departure from the spirit and scope of the invention, and all such modifications as would be obvious to one skilled in the art are intended for inclusion within the scope of the following claims.

1. An optical module, comprising:
a first substrate;
an electronic device provided on said first substrate;
an optical device electrically connected to said electronic device;
a fiber assembly optically coupled to said optical device; and
a housing for securing said fiber assembly, said housing including a cavity for enclosing said electronic device and said optical device and an opening leading to said cavity,
wherein said first substrate is provided in said opening.

2. The optical module according to claim 1, wherein
said housing includes a base and a cover, said base having a mounting region for mounting said optical device, said cover having said cavity, said base and said cover securing said fiber assembly therebetween.

3. The optical module according to claim 2, wherein
said cover has a first groove having a pair of surfaces for securing said fiber assembly.

4. The optical module according to claim 3, wherein
said fiber assembly includes an optical fiber and a ferrule for protecting said optical fiber, and
said first groove includes a pair of grooves, one of grooves securing said ferrule and the other of grooves securing said optical fiber.

5. The optical module according to claim 2, wherein
said base has a second groove having a pair of surfaces for securing said fiber assembly.

6. The optical module according to claim 5, wherein
said fiber assembly includes an optical fiber and a ferrule for protecting said optical fiber, and said first groove includes a pair of grooves, one of grooves securing said ferrule and the other of grooves securing said optical fiber.

7. The optical module according to claim 5, wherein
said optical device is a light-receiving device and
said base has a third groove extending from said second groove and having a light-reflecting surface,
said light-receiving device receiving light emitted from said fiber assembly and reflected by said light-reflecting surface of said third groove.

8. The optical module according to claim 1, wherein said optical module further comprises a bench for mounting said optical device, and wherein said housing includes a base and a cover, said base having said opening and a receiving portion for receiving said bench, said cover having said cavity, said bench and said cover securing said fiber assembly therebetween.

9. An optical communication apparatus, comprising:
an optical module including;
a first substrate;
an electronic device mounted on said first substrate;
an optical device connected to said electronic device;
a fiber assembly optically coupled to said optical device; and
a housing for securing said fiber assembly, said housing including a cavity for enclosing said electronic device and said optical device, and an opening leading to said cavity and providing said first substrate therein,
a second substrate for installing other electronic devices; and
a wiring member for connecting said first substrate of said optical module to said second substrate,
wherein said wiring member is resilient.

10. The optical communication apparatus according to claim 9, wherein said wiring member is a flexible printed board.

11. The optical communication apparatus according to claim 9, wherein said optical device is a light-emitting device, said electronic device provided in said optical module is a driver for driving said light-emitting device, and said other electronic devices constitutes a signal processing circuit for generating a signal provided to said driver.

12. The optical communication apparatus according to claim 9, wherein said optical device is a light-receiving device, said electronic device provided in said optical module is a preamplifier for amplifying a signal output from said light-receiving device, and said other electronic devices constitutes a signal processing circuit for processing a signal output from said preamplifier.

13. The optical communication apparatus according to claim 9, further includes a resin body for enclosing said optical module, said wiring member, said second substrate.

14. An optical transceiver, comprising:
a first optical communication apparatus comprising:
an optical module including;
a first substrate;
an electronic device mounted on said first substrate;
an optical device connected to said electronic device;
a fiber assembly optically coupled to said optical device; and
a housing for securing said fiber assembly, said housing including a cavity for enclosing said electronic device and said optical device, and an opening leading to said cavity and providing said first substrate therein,
a second substrate for installing other electronic devices; and
a wiring member for connecting said first substrate of said optical module to said second substrate,
wherein: said wiring member is resilient, said optical device is a light-emitting device, said electronic device provided in said optical module is a driver for driving said light-emitting device, and said other electronic devices constitutes a signal processing circuit for generating a signal provided to said driver;
a second optical communication apparatus according to claim 12; and
a housing for enclosing said first optical communication apparatus and said second optical communication apparatus.
